(19) United States
(12) Patent Application Publication
(10) Pub. No.: US 2023/0132045 A1
(43) Pub. Date: Apr. 27, 2023

(54) INFORMATION PROCESSING DEVICE, INFORMATION PROCESSING METHOD, AND RECORDING MEDIUM

(71) Applicant: SONY GROUP CORPORATION, TOKYO (JP)

(72) Inventors: FUJIO ARAI, TOKYO (JP); KAZUNORI ASAYAMA, TOKYO (JP); GEN HAMADA, TOKYO (JP); YU NAKADA, TOKYO (JP); SHUNITSU KOHARA, TOKYO (JP); HAJIME WAKABAYASHI, TOKYO (JP)

(21) Appl. No.: 17/905,435

(22) PCT Filed: Feb. 26, 2021
(86) PCT No.: PCT/JP2021/007328

§ 371 Date: Sep. 1, 2022

(30) Foreign Application Priority Data
Mar. 9, 2020 (JP) 2020-039990

(51) Int. Cl. G06T 3/40; G06T 17/00; G06T 5/50; G06T 7/73; G06F 3/01; G06F 3/04817; G02B 27/01

(52) U.S. Cl. CPC G06T 3/4053; G06T 17/00; G06T 5/50; G06T 7/73; G06F 3/013; G06F 3/04817; G02B 27/0172; G06T 2207/20221

(57) ABSTRACT

Provided is an information processing device, an information processing method, and a recording medium capable of suppressing a decrease in visibility of a display image in a case where a user's line of sight moves at a high speed. An information processing device (1) according to the present disclosure includes a resolution control unit (14). The resolution control unit (14) sets a high-resolution region including a gaze point of a user and a low-resolution region not including the gaze point of the user to a display image displayed by a display device and temporarily expands the high-resolution region toward a virtual object in a case where the virtual object enters the high-resolution region.

### FIELD

The present disclosure relates to an information processing device, an information processing method, and a recording medium.

### BACKGROUND

Foveated rendering is one of methods for reducing the processing load of rendering images. Foveated rendering is a method of rendering an image by setting a high-resolution region including a user's gaze point and a low-resolution region not including the user's gaze point to a display image displayed by a display device. According to the foveated rendering, it is possible to reduce the drawing processing load of the low-resolution region.

Information processing devices that perform the foveated rendering detect a line of sight of a user, calculates the position of a high image quality region on the basis of a gaze point of the user, and performs image rendering (see, for example, Patent Literatures 1 and 2).

### CITATION LIST

### Patent Literatures

Patent Literature 1: JP 2016-191845 A
Patent Literature 2: WO 2019/031005 A

### SUMMARY

### Technical Problem

However, in a case where the line of sight of a user moves at a high speed, the information processing devices cannot cause the high-resolution region to follow the movement of the line of sight, and the visibility of the display image may be deteriorated.

Therefore, the present disclosure proposes an information processing device, an information processing method, and a recording medium capable of suppressing a decrease in visibility of a display image in a case where a user's line of sight moves at a high speed.

### Solution to Problem

According to the present disclosure, an information processing device is provided. The information processing device, an information processing method, and a recording medium capable of suppressing a decrease in visibility of a display image in a case where a user's line of sight moves at a high speed. An information processing device according to the present disclosure includes a resolution control unit. The resolution control unit sets a high-resolution region including a gaze point of a user and a low-resolution region not including the gaze point of the user to a display image displayed by a display device and temporarily expands the high-resolution region toward a virtual object in a case where the virtual object enters the high-resolution region.

### BRIEF DESCRIPTION OF DRAWINGS

FIG. 1 is a diagram illustrating the appearance of an information processing device according to the present disclosure.

FIG. 2A is a diagram illustrating a first image display mode according to the present disclosure.

FIG. 2B is a diagram illustrating the first image display mode according to the present disclosure.

FIG. 2C is a diagram illustrating the first image display mode according to the present disclosure.

FIG. 3 is a block diagram illustrating an example of a configuration of the information processing device according to the present disclosure.

FIG. 4 is a flowchart illustrating processing executed by the information processing device according to the present disclosure.

FIG. 5 is a flowchart illustrating processing executed by a resolution control unit according to the present disclosure.

FIG. 6 is an explanatory diagram illustrating a method for determining a gaze point and a gaze region according to the present disclosure.

FIG. 7A is a diagram illustrating a second image display mode according to the present disclosure.

FIG. 7B is a diagram illustrating the second image display mode according to the present disclosure.

FIG. 7C is a diagram illustrating the second image display mode according to the present disclosure.

FIG. 7D is a diagram illustrating a second image display mode according to the present disclosure.

FIG. 8A is a diagram illustrating a third image display mode according to the present disclosure.

FIG. 8B is a diagram illustrating the third image display mode according to the present disclosure.

FIG. 8C is a diagram illustrating the third image display mode according to the present disclosure.

FIG. 8D is a diagram illustrating the third image display mode according to the present disclosure.

FIG. 8E is a diagram illustrating the third image display mode according to the present disclosure.

FIG. 9A is a diagram illustrating a fourth image display mode according to the present disclosure.

FIG. 9B is a diagram illustrating a modification of the fourth image display mode according to the present disclosure.

### DESCRIPTION OF EMBODIMENTS

Hereinafter, embodiments of the present disclosure will be described in detail on the basis of the drawings. Note that in each of the following embodiments, the same parts are denoted by the same symbol, and redundant description will be omitted.

[1. Overview of Information Processing Device]

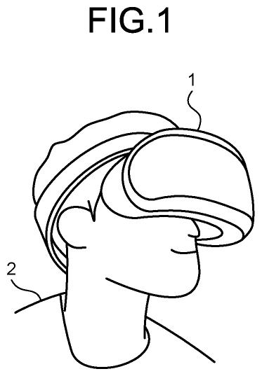

As illustrated in FIG. 1, an information processing device 1 according to the present disclosure is a head-mounted display that is worn on the head of a user 2 and causes the user 2 to visually recognize a display image. The head-mounted display is roughly categorized into non-transmissive displays and transmissive displays. The non-transmissive display causes a display that shields the user's field of view to display an image. The non-transmissive display is mainly used for virtual reality (VR) experience.

Moreover, the transmissive displays are roughly categorized into video see-through displays and optical see-through displays. A video see-through display captures and displays the real space in front of the user 2 and superimposes and displays an object on a display image. An optical display superimposes and displays an object on a display such as a one-way mirror that does not block a user's field of view. The transmissive displays are mainly used for augmented reality (AR) experience.

Note that, since the video see-through displays can switch between being transparent and non-transparent, the video see-through displays are used for both the VR experience and the AR experience. Hereinafter, a case where the information processing device 1 is a video see-through display will be described as an example, however, the information processing device 1 may be an optical see-through display or a non-transmissive display.

The information processing device 1 performs foveated rendering that reduces the drawing processing load by setting a high-resolution region including a gaze point of the user 2 and a low-resolution region not including the gaze point of the user 2 to a display image. Furthermore, the information processing device 1 has a function of superimposing and displaying a virtual object on the display image of the real space as effects.

In a case where the rendering load of the virtual object is reduced by foveated rendering, when the user 2 quickly moves the line of sight, switching the resolution cannot be performed in time, and the display becomes blurred unless the movement of the line of sight can be observed and estimated quickly and accurately.

Therefore, if the high-resolution region is set in a wide range, it is possible to prevent blurring of the virtual object ahead of the line of sight even if the user 2 quickly moves the line of sight, however, the processing load of rendering increases.

Meanwhile, it is possible to reduce the latency of eye tracking or rendering by using a processor capable of high-speed processing, however, the head-mounted display becomes large and subjected to high load, and thus the power consumption increases. That is, it is not possible to reduce the power consumption and the size of the head-mounted display.

Therefore, the information processing device 1 according to the present disclosure sets a high-resolution region including the gaze point of the user 2 and a low-resolution region not including the gaze point of the user 2 to a display image displayed by the display device and temporarily expands the high-resolution region toward the virtual object in a case where the virtual object enters the high-resolution region.

As a result, in a case where the user 2 moves the line of sight at a high speed and follows the virtual object with the eyes, the information processing device 1 can include, in the high-resolution region, a region of the virtual object that cannot be covered by a high-resolution region to be set by normal foveated rendering. Therefore, the information processing device 1 can suppress a decrease in the visibility of the display image in a case where the line of sight of the user 2 moves at a high speed.

There is a high possibility that the user 2 quickly moves the line of sight when a virtual object satisfying the following condition is displayed. Therefore, the information processing device 1 shifts from a normal foveated rendering mode to a foveated rendering expansion mode in which the high-resolution region is temporarily expanded toward the virtual object.

Examples of the condition of an object that the user 2 is likely to quickly move the line of sight include virtual objects superimposed and displayed on a real object such as a ball of a sport that quickly moves or a player running around on a field.

Examples of other conditions include a plurality of virtual objects such as an opponent, a target, or a bullet of a game that can be a target of a user action such as attack, avoidance, or contact in a video game. Examples of further other conditions include a list of a plurality of similar virtual objects such as selection items on a setting screen.

[2. First Image Display Mode]

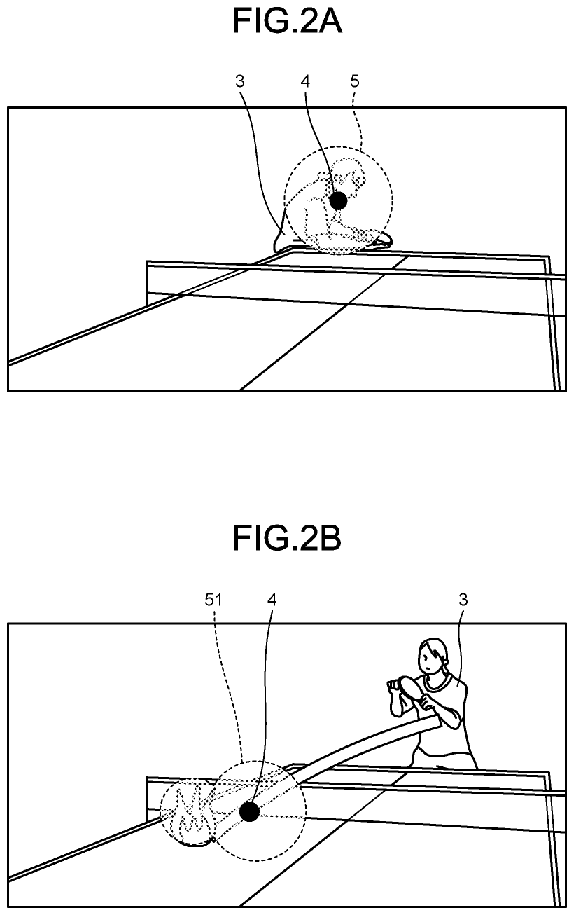

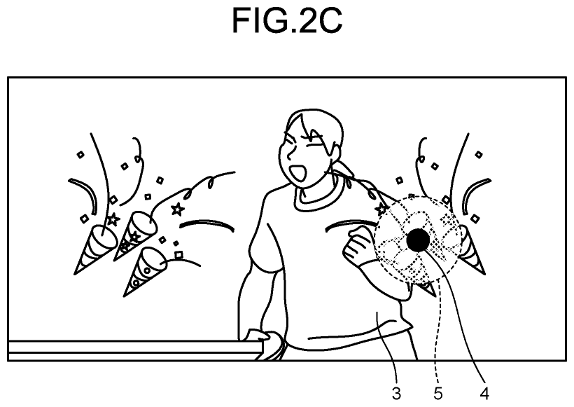

Next, a first display mode performed by the information processing device 1 according to the present disclosure will be described with reference to FIGS. 2A to 2C. FIGS. 2A to 2C are diagrams illustrating the first image display mode according to the present disclosure. A case where the user 2 wearing the information processing device 1 plays table tennis will be described as an example.

As illustrated in FIG. 2A, the information processing device 1 displays an image obtained by capturing an image of the real space in front of the eyes of the user 2. At this point, the information processing device 1 performs resolution control in the normal foveated rendering mode.

In a case where the user 2 is gazing at an opponent player 3 before serving, the information processing device 1 sets a high-resolution region 5 in a gaze region including a gaze point 4 and a low-resolution region to the outside of the high-resolution region 5 and performs rendering.

Then, as illustrated in FIG. 2B, when a rally starts, the gaze point of the line of sight of the user 2 tends to follow a ball that is quickly moving. At this point, for example, in a case where a virtual object of flame is superimposed on the ball, if the information processing device 1 cannot quickly capture the movement of the line of sight, the virtual object superimposed on the ball is drawn with low resolution by foveated rendering.

Here, the virtual object of the flame superimposed on the ball is a moving object that can move in the virtual space, an object that quickly moves together with the ball in the three-dimensional space, and an object having visual attraction greater than or equal to a predetermined value. That is, this virtual object satisfies the condition of the object that the user 2 is likely to quickly move the line of sight.

Therefore, when a rally starts, the information processing device 1 shifts to the foveated rendering expansion mode and sets a high-resolution region 51 temporarily expanded toward the virtual object.

As a result, in a case where the information processing device 1 cannot follow the quick movement of the line of sight of the user 2 and detects a gaze point temporally preceding an actual gaze point, the virtual object is included in the expanded high-resolution region 51, and thus the virtual object can be displayed at high resolution.

Furthermore, the information processing device 1 sets the high-resolution region 51 expanded in a non-circular shape in the foveated rendering expansion mode. As a result, the information processing device 1 can expand the high-resolution region so as to have an appropriate shape depending on the situation.

Furthermore, the information processing device 1 sets the high-resolution region 51 expanded in a non-circular shape corresponding to the shape of the virtual object in the foveated rendering expansion mode. For example, the information processing device 1 can set a high-resolution region having a rectangular shape or an elliptical shape enclosing a virtual object or a high-resolution region having the same shape as that of the virtual object. As a result, the information processing device 1 can reduce the processing load by minimizing the expansion range of the high-resolution region to the necessary minimum that matches the shape of the virtual object.

Then, as illustrated in FIG. 2C, the information processing device 1 returns to the normal foveated rendering mode when the rally ends, the ball disappears from the field of view of the user 2, and the virtual object superimposed on the ball disappears.

As described above, in a case where the virtual object disappears from the display image, the information processing device 1 returns the high-resolution region 51 to the high-resolution region 5 having the size before the expansion. As a result, in a case where no virtual object is displayed, the information processing device 1 can reduce the processing load by minimizing the range of the high-resolution region to the necessary minimum.

[3. Configuration of Information Processing Device]

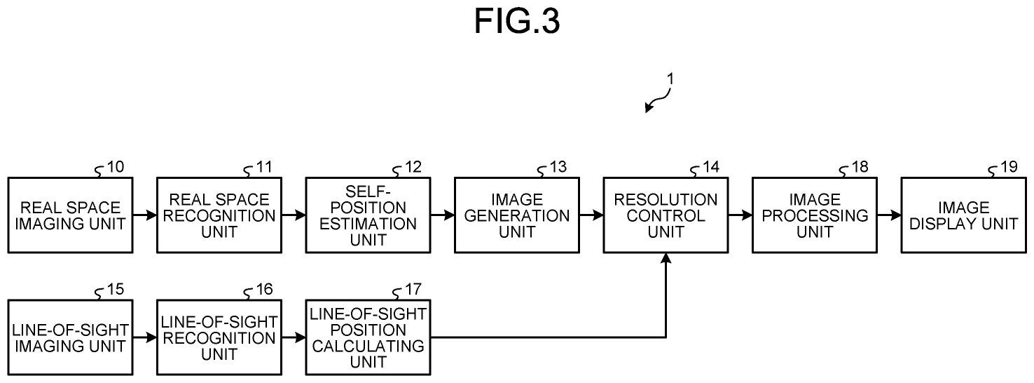

Next, a configuration of the information processing device 1 according to the present disclosure will be described with reference to FIG. 3. FIG. 3 is a block diagram illustrating an example of the configuration of the information processing device according to the present disclosure. As illustrated in FIG. 3, the information processing device 1 includes a real space imaging unit 10, a real space recognition unit 11, a self-position estimation unit 12, an image generation unit 13, a resolution control unit 14, a line-of-sight imaging unit 15, a line-of-sight recognition unit 16, a line-of-sight position calculating unit 17, an image processing unit 18, and an image display unit 19.

The real space imaging unit 10 and the line-of-sight imaging unit 15 are, for example, cameras including a complementary metal oxide semiconductor (CMOS) image sensors. The image display unit 19 is a display device that projects a display image on a screen of the head-mounted display.

The real space recognition unit 11, the self-position estimation unit 12, the image generation unit 13, the resolution control unit 14, the line-of-sight recognition unit 16, the line-of-sight position calculating unit 17, and the image processing unit 18 are implemented by, for example, an electronic circuit such as a central processing unit (CPU) or a microprocessor.

The real space recognition unit 11, the self-position estimation unit 12, the image generation unit 13, the resolution control unit 14, the line-of-sight recognition unit 16, the line-of-sight position calculating unit 17, and the image processing unit 18 may include a read only memory (ROM) that stores programs, calculation parameters, and the like to be used and a random access memory (RAM) that temporarily stores parameters or the like that fluctuate as appropriate.

The real space imaging unit 10 images the real space in front of the eyes of the user 2 and outputs the captured image to the real space recognition unit 11. The real space recognition unit 11 recognizes feature points of the real space from the captured image captured by the real space imaging unit 10 and outputs the recognition result to the self-position estimation unit 12.

The self-position estimation unit 12 estimates the self-position of the user 2 in the virtual space on the basis of the feature points of the real space recognized by the real space recognition unit 11 and outputs the estimation result to the image generation unit 13. The image generation unit 13 generates a virtual object to be superimposed and displayed on the captured image in which the real space is captured.

The image generation unit 13 generates the virtual object matching the real space (real world) on the basis of the self-position estimated by the self-position estimation unit 12 and outputs the captured image of the real space on which the virtual object is superimposed to the resolution control unit 14.

The line-of-sight imaging unit 15 captures an image of the eyes of the user 2 and outputs the captured image to the line-of-sight recognition unit 16. The line-of-sight recognition unit 16 recognizes feature points of the eyes of the user 2 from the captured image captured by the line-of-sight imaging unit 15 and outputs the recognition result to the line-of-sight position calculating unit 17.

The line-of-sight position calculating unit 17 calculates the gaze point 4 of the user 2 on the basis of feature points of the eyes recognized by the line-of-sight recognition unit 16 and outputs the calculation result to the resolution control unit 14. In a case where no virtual object enters the high-resolution region 5 including the gaze point 4 of the user 2, the resolution control unit 14 performs the normal foveated rendering.

As a result, the resolution control unit 14 can reduce the processing load of the drawing processing by setting a region other than the high-resolution region 5 including the gaze point 4 of the user 2 in an image generated by the image generation unit 13 as the low-resolution region.

Furthermore, in a case where a virtual object enters the high-resolution region 5 including the gaze point 4 of the user 2, the resolution control unit 14 shifts to the foveated rendering expansion mode and sets the high-resolution region 51 temporarily expanded toward the virtual object (see FIG. 2B).

Specifically, when having detected the line of sight of the user 2, the resolution control unit 14 confirms whether or not a virtual object is present in the high-resolution region 5 that is the gaze region ahead of the line of sight. In a case where there is a virtual object, the resolution control unit 14 confirms the attribute of the virtual object.

The resolution control unit 14 shifts from the normal foveated rendering mode to the foveated rendering expansion mode in a case where the attribute of the virtual object is those that are superimposed on a real object that moves quickly, a target of a user action such as an attack, avoidance, or contact in a game, or a list of a plurality of similar virtual objects.

In a case where the attribute of the virtual object is a virtual object that does not meet these conditions, the resolution control unit 14 performs resolution control in the normal foveated rendering mode. In the normal foveated rendering mode, the resolution control unit 14 sets only the gaze region ahead of the line of sight to the high-resolution region 5 and sets the other parts to the low-resolution region with lower resolution to perform drawing.

In the foveated rendering expansion mode, the resolution control unit 14 increases the resolution not only for the gaze region ahead of the line of sight but also for a specific virtual object. In the foveated rendering expansion mode, the resolution control unit 14 first detects a virtual object belonging to the same group having the same attribute as that of the virtual object ahead of the line of sight.

Then, the resolution control unit 14 sets high resolution to the virtual objects belonging to the same group being drawn and performs drawing. The resolution control unit 14 maintains this state until all the virtual objects belonging to the same group disappear, and when all the virtual objects have disappeared, transition to the normal foveated rendering mode is made, and only the gaze region is set to high resolution to perform drawing.

Each virtual object has a flag for setting in advance whether or not to apply the foveated rendering expansion mode depending on the attribute thereof. In addition, a group of highly relevant virtual objects with which the user 2 is likely to look at simultaneously while moving the line of sight quickly is defined as one group.

The highly relevant virtual objects correspond to, for example, a group of opponents or targets that are attack targets of a game, a group of icons of setting items that function as a graphical user interface that receives operation input of the user 2, and the like having a similar shape and the same characteristic of the user action. The resolution control unit 14 outputs, to the image processing unit 18, an image subjected to resolution control in the normal foveated rendering mode or the foveated rendering expansion mode.

The image processing unit 18 performs image processing such as color and brightness adjustment, correction of a display position of the virtual objects, and noise reduction on the image input from the resolution control unit 14 in order to draw the image on the image display unit 19 depending on the resolution. The image processing unit 18 outputs the image after the image processing to the image display unit 19. The image display unit 19 displays the image input from the image processing unit 18 on an optical system display.

[4. Processing Executed by Information Processing]

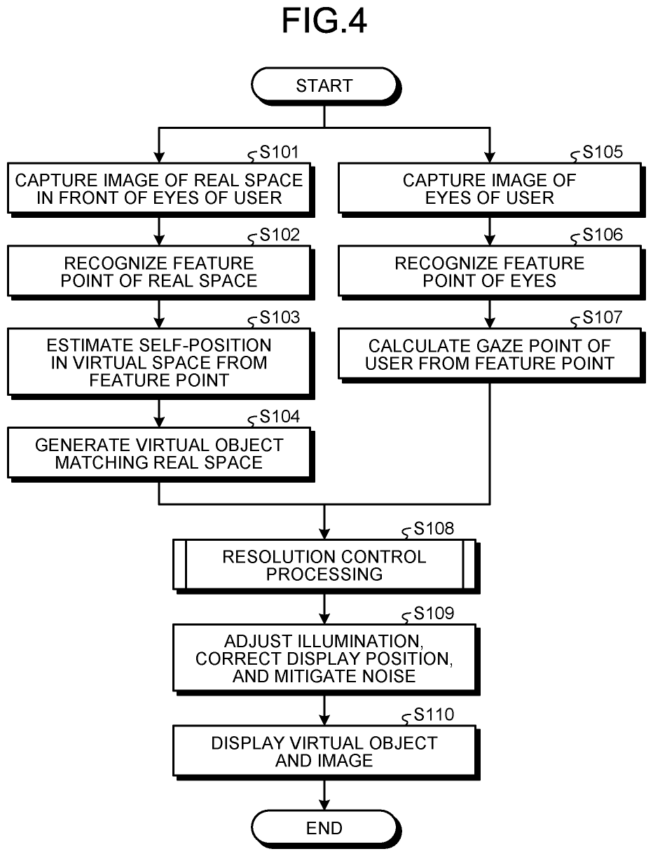

Next, processing executed by the information processing device 1 according to the present disclosure will be described with reference to FIG. 4. FIG. 4 is a flowchart illustrating the processing executed by the information processing device according to the present disclosure. As illustrated in FIG. 4, the real space imaging unit 10 captures an image of the real space in front of the eyes of the user 2 (step S101). Subsequently, the real space recognition unit 11 recognizes feature points of the real space on the basis of the image captured by the real space imaging unit 10 (step S102).

Then, the self-position estimation unit 12 estimates the self-position in the virtual space from the feature points of the real space (step S103). Subsequently, the image generation unit 13 generates a virtual object matching the real space (step S104) and generates an image of the real space on which the virtual object is superimposed.

In addition, the information processing device 1 executes steps S105 to S107 in parallel with the processing of steps S101 to S104. Specifically, the line-of-sight imaging unit 15 captures an image of the eyes of the user 2 (step S105). Subsequently, the line-of-sight recognition unit 16 recognizes feature points of the eyes from the image of the eyes captured by the line-of-sight imaging unit 15 (step S106). Then, the line-of-sight position calculating unit 17 calculates the gaze point 4 of the user 2 from the feature points of the eyes.

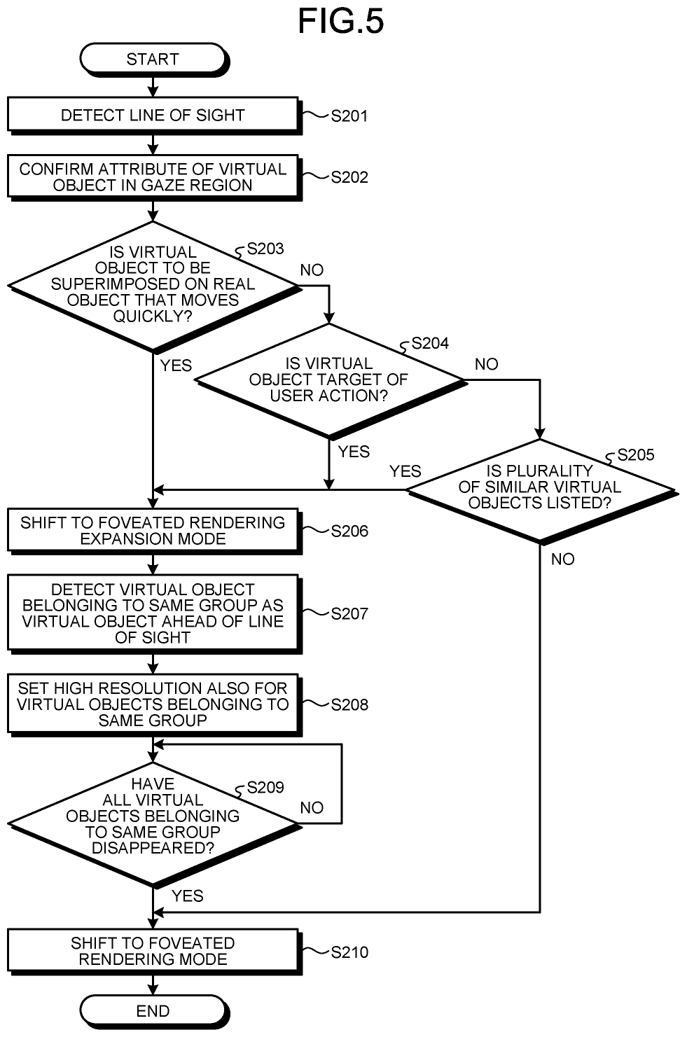

Then, the resolution control unit 14 executes resolution control processing (step S108). In the resolution control processing, the resolution control unit 14 sets the high-resolution region 5 including the gaze point 4 of the user 2 and the low-resolution region not including the gaze point 4 of the user 2 to the display image displayed by the display device. Then, in a case where a virtual object enters the high-resolution region 5, the resolution control unit 14 temporarily expands the high-resolution region 5 toward the virtual object. Details of the resolution control processing will be described later with reference to FIG. 5.

Then, the image processing unit 18 performs image processing such as luminance adjustment of the display image, display position correction of the virtual object, and noise reduction (step S109). Then, the image display unit 19 displays the virtual object and the image having been subjected to the image processing by the image processing unit 18 (step S110) and ends the processing.

Next, the resolution control processing according to the present disclosure will be described with reference to FIG. 5. FIG. 5 is a flowchart illustrating processing executed by the resolution control unit according to the present disclosure. As illustrated in FIG. 5, the resolution control unit 14 detects the line of sight of the user 2 on the basis of the gaze point 4 of the user 2 calculated by the line-of-sight position calculating unit 17 (step S201) and confirms the attribute of the virtual object in the gaze region that is the high-resolution region 5 (step S202).

Then, the resolution control unit 14 determines whether or not the virtual object is one of those whose attribute is to be superimposed on a real object that moves quickly (step S203). Then, if the resolution control unit 14 determines that the virtual object is to be superimposed on a real object that moves quickly (step S203, Yes), the processing proceeds to step S206.

On the other hand, if it is determined that the virtual object is not to be superimposed on a real object that moves quickly (step S203, No), the resolution control unit 14 determines whether or not the attribute of the virtual object is a target of a user action (step S204).

Then, if the resolution control unit 14 determines that the virtual object is a target of a user action (step S204, Yes), the processing proceeds to step S206. On the other hand, if it is determined that the virtual object is not a target of a user action (step S204, No), the resolution control unit 14 determines whether or not there is a plurality of similar virtual objects (step S205).

Then, if the resolution control unit 14 determines that there is a plurality of similar virtual objects (step S205, Yes), the processing proceeds to step S206. On the other hand, if the resolution control unit 14 determines that there is no plurality of similar virtual objects (step S205, No), the processing proceeds to step S210.

In step S206, the resolution control unit 14 shifts to the foveated rendering expansion mode. Then, the resolution control unit 14 detects a virtual object having the same attribute and belonging to the same group as the virtual object that is ahead of the line of sight (step S207).

Subsequently, the resolution control unit 14 sets high resolution also for the virtual objects belonging to the same group (step S208) and determines whether or not all the virtual objects belonging to the same group have disappeared (step S209).

If it is determined that not all the virtual objects belonging to the same group have disappeared (step S209, No), the resolution control unit 14 repeats the determination in step S209 until all the virtual objects belonging to the same group disappear.

Then, if it is determined that all the virtual objects belonging to the same group have disappeared (step S209, Yes), the resolution control unit 14 shifts to the foveated rendering mode (step S210) and ends the resolution control processing. Then, the resolution control unit 14 starts the resolution control processing again from step S201.

[5. Method of Determining Gaze Point and Gaze Region]

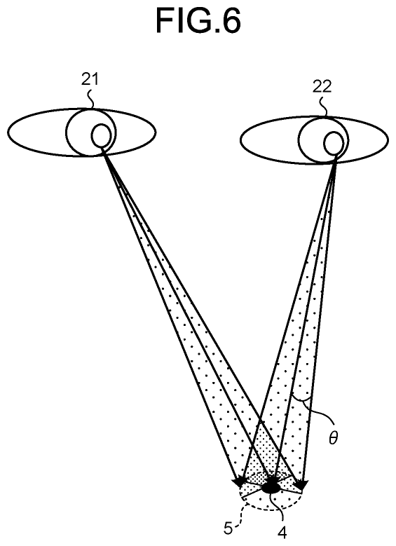

Next, a method of determining a gaze point and a gaze region according to the present disclosure will be described with reference to FIG. 6. FIG. 6 is an explanatory diagram illustrating a method for determining a gaze point and a gaze region according to the present disclosure. As illustrated in FIG. 6, first, line-of-sight directions (line-of-sight vectors) are calculated from an image of the eyes 21 and 22 of the user 2 captured by the line-of-sight imaging unit 15.

A point at which the line-of-sight vectors of the left and right eyes 21 and 22 intersect is defined as the gaze point 4, and a range of a predetermined angle θ (for example, a range with a radius of 2 to 5 degrees) around the gaze point 4 is determined as the gaze region, which is set as the high-resolution region 5 including the gaze point 4.

In a case where even a part of a virtual object to be drawn is present on a coordinate point of the gaze region, the resolution control unit 14 defines the virtual object as a virtual object present in the gaze region ahead of the line of sight.

[6. Second Image Display Mode]

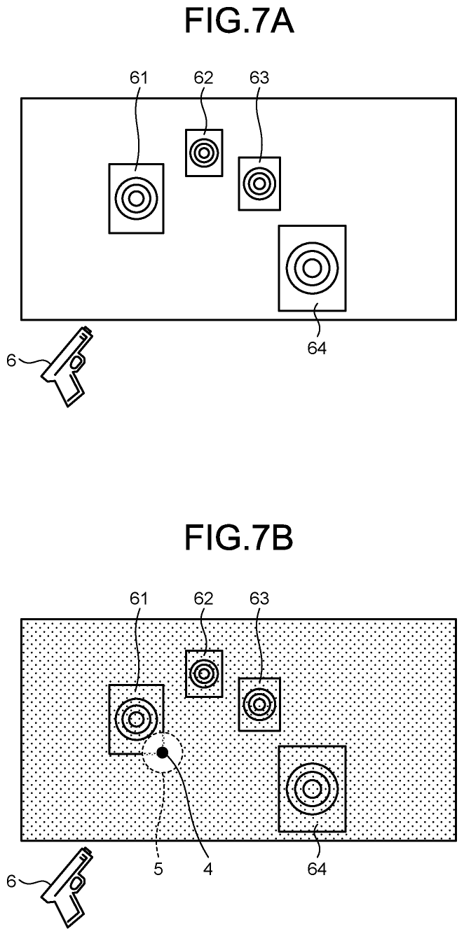

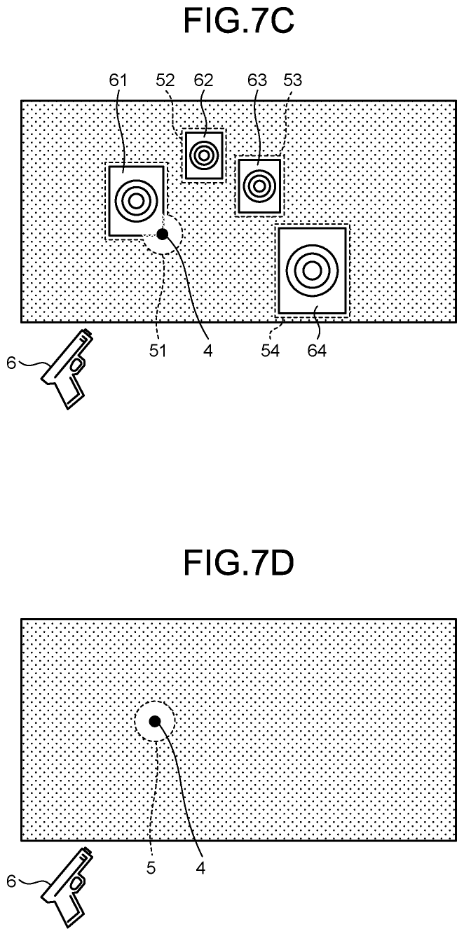

Next, a second display mode performed by the information processing device 1 according to the present disclosure will be described with reference to FIGS. 7A to 7D. FIGS. 7A to 7D are diagrams illustrating the second image display mode according to the present disclosure. Here, a case where the information processing device 1 displays targets as a plurality of virtual objects to be subjected to user actions in a shooting game will be described as an example.

As illustrated in FIG. 7A, in a case where the user 2 plays a shooting game, the information processing device 1 displays virtual objects of a plurality of targets 61, 62, 63, and 64. An attribute is associated with each of the virtual objects of the targets 61, 62, 63, and 64. For example, the targets 61, 62, 63, and 64 are associated with the same attribute that they are to be subjected to user actions.

Next, as illustrated in FIG. 7B, the information processing device 1 performs rendering in the normal foveated rendering mode, sets the gaze region including the gaze point 4 of the user 2 as the high-resolution region 5, and sets a region other than the high-resolution region 5 as the low-resolution region.

In this situation, when a part of the virtual object of the target 61 enters the high-resolution region 5, the information processing device 1 confirms the attribute of the virtual object of the target 61. At this point, it is based on the presumption that the attribute of the virtual object of the target 61 is to be subject to a user action and is set a flag for enabling the foveated rendering expansion mode.

In such a case, the information processing device 1 confirms the group to which the virtual object of the target 61 belong and sets high resolution to the other targets 62, 63, and 64 in the group of the same attribute among virtual objects being drawn as illustrated in FIG. 7C.

In the example illustrated in FIG. 7C, the virtual objects of the targets 61, 62, 63, and 64 belong to the same group, and the four virtual objects are drawn with high resolution. Specifically, the information processing device 1 sets the high-resolution region 51 temporarily expanded toward the target 61 and further sets high-resolution regions 52, 53, and 54 expanded to regions including the other targets 62, 63, and 64.

At this point, the information processing device 1 expands each of the high-resolution regions 51, 52, 53, and 54 in a non-circular shape. In the example illustrated in FIG. 7C, the information processing device 1 expands the high-resolution regions 51, 52, 53, and 54 in a rectangular shape enclosing the targets 61, 62, 63, and 64, respectively. Note that the information processing device 1 can also expand the high-resolution regions 51, 52, 53, and 54 in another non-circular shape such as an elliptical shape.

Furthermore, in this shooting game, the targets 61, 62, 63, and 64 disappear when the user 2 fires a virtual bullet at and hits the targets 61, 62, 63, and 64. For this reason, there is a high possibility that the line of sight moves quickly when the user 2 shoots while sequentially focusing the line of sight to the targets 61, 62, 63, and 64.

In the normal foveated rendering mode, due to a delay in line-of-sight recognition or a delay in resolution change, there are cases where setting a high-resolution region is not in time for quick movement of the line-of-sight and the targets 61, 62, 63, and 64 ahead of the line of sight are displayed with low resolution.

Therefore, in a case where there is a high possibility that the line of sight moves quickly, the information processing device 1 shifts to the foveated rendering expansion mode as described above. In the foveated rendering expansion mode, since the targets 61, 62, 63, and 64, with which the line of sight is likely to be moved, are displayed in high resolution in advance, it is possible to prevent the user 2 from gazing at a target with low resolution even when the line of sight suddenly moves.

For example, in a case where the target 61 is hit and the target 61 disappears, the information processing device 1 stops high resolution drawing for the region where the target 61 has been and returns to the normal foveated rendering mode when all the targets 61, 62, 63, and 64 disappear as illustrated in FIG. 7D.

[7. Third Image Display Mode]

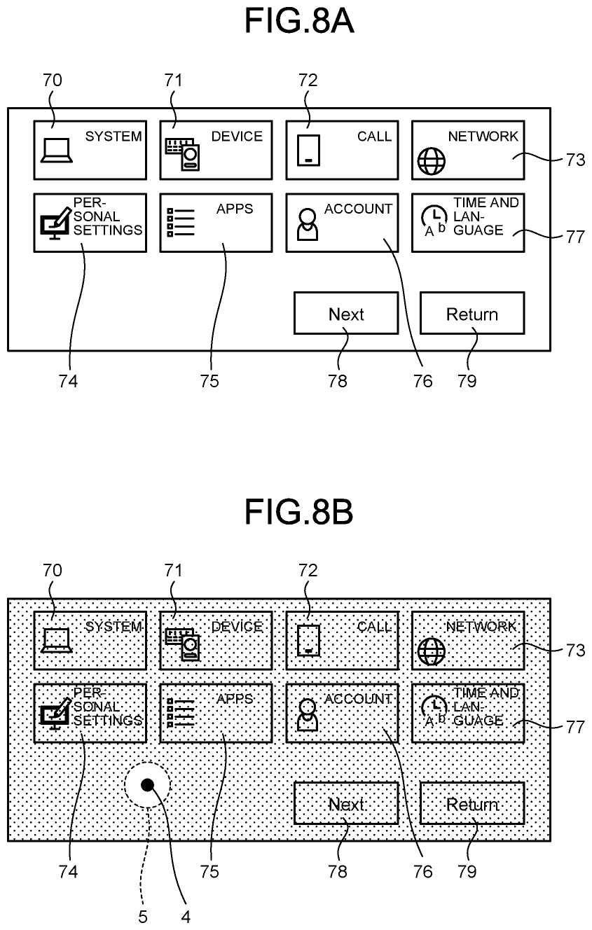

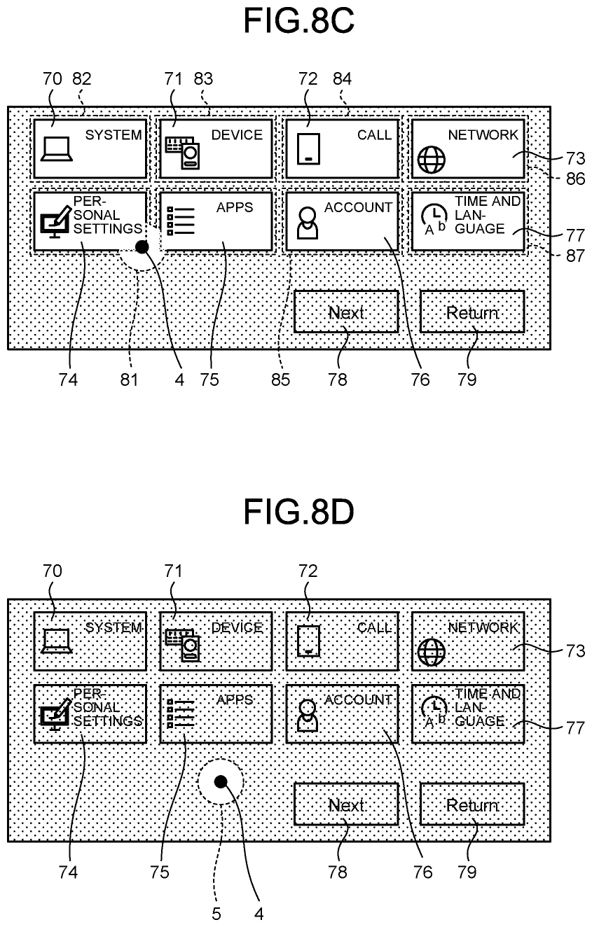

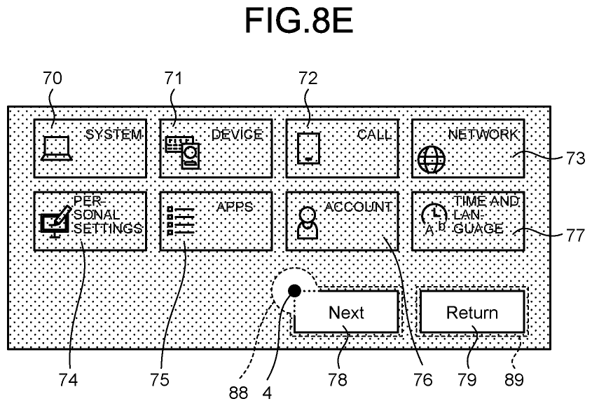

Next, a third display mode performed by the information processing device 1 according to the present disclosure will be described with reference to FIGS. 8A to 8E. FIGS. 8A to 8E are diagrams illustrating the third image display mode according to the present disclosure. Here, a case will be described as an example where the information processing device 1 displays a group of icons of setting items serving as a graphical user interface as an example of a plurality of similar virtual objects that is listed.

As illustrated in FIG. 8A, the information processing device 1 may display a plurality of virtual objects indicating setting item icons 70 to 79. Each of the plurality of virtual objects indicating the setting item icons 70 to 79 is associated with an attribute.

For example, the setting item icons 70 to 77 are associated with an attribute of listed first similar virtual objects. Meanwhile, the setting item icons 78 and 79 are associated with an attribute of listed second similar virtual objects.

In this case, as illustrated in FIG. 8B, the information processing device 1 first performs rendering in the normal foveated rendering mode, sets the gaze region including the gaze point 4 of the user 2 as the high-resolution region 5, and sets a region other than the high-resolution region 5 as the low-resolution region.

Then, as illustrated in FIG. 8C, when the line of sight of the user 2 moves to a virtual object of the setting item icon 74, the information processing device 1 confirms the attribute of the virtual object. At this point, it is based on the presumption that the virtual object of the setting item icon 74 has an attribute as listed similar virtual objects and is set with a flag for enabling the foveated rendering expansion mode.

In such a case, the information processing device 1 confirms the group to which the virtual object of the setting item icon 74 belongs and sets the other setting item icons 70 to 73 and 75 to 77 that are in the same group and are drawn to have high resolution as illustrated in FIG. 8C.

In the example illustrated in FIG. 8C, the eight setting item icons 70 to 77 arranged in the upper rows belong to the same group, and drawing is performed with high resolution on these eight virtual objects. Specifically, the information processing device 1 sets a high-resolution region 81 temporarily expanded toward the setting item icons 74 and 75 and further sets high-resolution regions 82 to 87 expanded to regions including the other setting item icons 70 to 73, 76, and 77.

At this point, the information processing device 1 expands the high-resolution regions 81 to 87 in a non-circular shape. In the example illustrated in FIG. 8C, the information processing device 1 expands the high-resolution regions 81 to 87 in rectangular shapes each enclosing the setting item icons 70 to 77. Note that the information processing device 1 can also expand the high-resolution regions 81 to 87 in other non-circular shapes such as an elliptical shape.

Furthermore, in a case where a plurality of objects having the same shape as the setting item icons 70 to 77 is aligned, there is a high possibility that the user 2 quickly moves the line of sight to take a quick look at all the items and searches for a desired item. In the normal foveated rendering mode, in a case where processing cannot be performed at a high speed, the setting of the high-resolution region cannot be performed in time for the movement of the line of sight, and the setting item icons 70 to 77 ahead of the line of sight may be displayed at low resolution.

Therefore, the information processing device 1 displays all the related setting item icons 70 to 77 in high resolution. As a result, the information processing device 1 can suppress a decrease in the visibility of the setting item icons 70 to 77 even in a case where the user 2 quickly moves the line of sight.

Moreover, as illustrated in FIG. 8D, in a case where the gaze region is out of the group of virtual objects to be subjected to the foveated rendering expansion mode, the information processing device 1 returns to the normal foveated rendering mode.

Then, as illustrated in FIG. 8E, the user 2 may move the gaze region to the setting item icons 78 and 79, which are other virtual objects to be subjected to the foveated rendering expansion mode. In this case, the information processing device 1 applies the foveated rendering expansion mode to the virtual objects in the same group, sets the high-resolution regions 88 and 89 temporarily expanded toward the setting item icons 78 and 79, and performs drawing with high resolution.

[8. Fourth Image Display Mode]

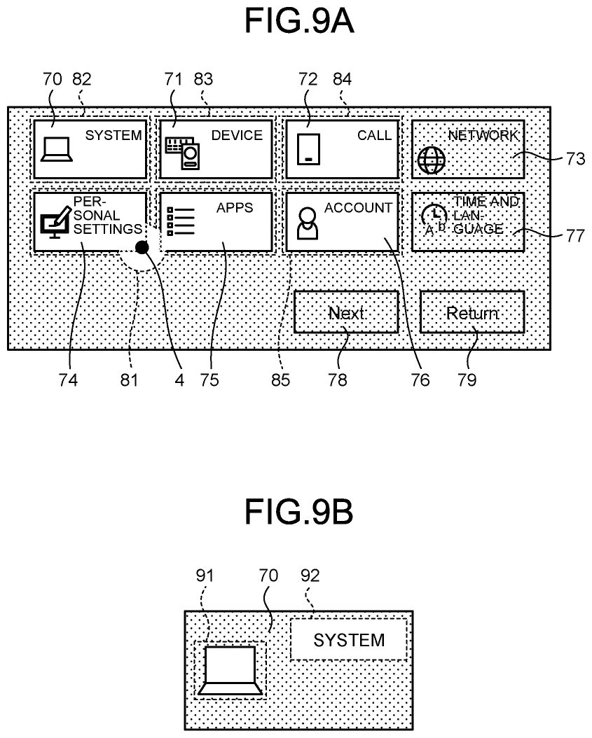

Next, a fourth display mode performed by the information processing device 1 according to the present disclosure will be described with reference to FIGS. 9A and 9B. FIG. 9A is a diagram illustrating the fourth image display mode according to the present disclosure. FIG. 9B is a diagram illustrating a modification of the fourth image display mode according to the present disclosure.

When the information processing device 1 shifts to the foveated rendering expansion mode, it can prevent cases where the processing cannot catch up with a the quick movement of the line of sight and viewing with low resolution occurs, however, the drawing load may increase due to an increase of the region where high-resolution processing is required.

Therefore, as illustrated in FIG. 9A, the information processing device 1 can set the setting item icons 70 to 77, which are a plurality of virtual objects belonging to the same group and are relatively close to the gaze point 4 of the user 2 to have high resolution and set setting item icons distant from the gaze point 4 to have low resolution.

In the example illustrated in FIG. 9A, the information processing device 1 sets the high-resolution regions 81 to 85 by expanding the high-resolution regions 81 to 85 to regions including the setting item icons 70 to 72 and 74 to 76, displayed in a region where the distance from the gaze point 4 of the user 2 is equal to or less than a threshold value, among the plurality of setting item icons 70 to 77.

In addition, the setting item icon 70 may include text information (such as characters “system”) or image information (such as “Illustration of a laptop computer”). In this case, as illustrated in FIG. 9B, the information processing device 1 can lower the drawing load by setting the portions of the characters or the image in the setting item icon 70 to high-resolution regions 91 and 92 and setting the other portion to a low-resolution region.

Furthermore, in a case where the image display unit 19 is a non-transmissive display that displays virtual reality (VR), the resolution control unit 14 of the information processing device 1 first detects a virtual object included in the gaze region.

Then, similarly to the above-described embodiment, the resolution control unit 14 shifts to the foveated rendering expansion mode as necessary and sets a high-resolution region also to a virtual object other than the gaze region.

Furthermore, in the normal foveated rendering mode, as for a background image generated by the image generation unit 13, the resolution control unit 14 sets a high-resolution region to the gaze region and sets a low-resolution region to the other region.

However, in the case of the foveated rendering expansion mode, since the user 2 quickly moves the line of sight, the resolution control unit 14 can reduce the processing load by setting the entire background image in virtual reality as a low-resolution region.

[9. Effects]

The information processing device 1 includes the resolution control unit 14. The resolution control unit 14 sets a high-resolution region including a gaze point of a user and a low-resolution region not including the gaze point of the user to a display image displayed by a display device and temporarily expands the high-resolution region toward a virtual object in a case where the virtual object enters the high-resolution region. As a result, the information processing device 1 can reduce the drawing load of the virtual object without deteriorating the visibility at the time of quick movement of the line of sight even in a power-saving and small head-mounted display having no high-speed processing mechanism, for example.

In addition, the virtual object is an object that moves in a three-dimensional virtual space. As a result, the information processing device 1 can suppress a decrease in the visibility of the virtual object when the virtual object moves at a high speed in the three-dimensional virtual space. Furthermore, for example, in a case where a virtual object is superimposed on a person or an object that is considered to move quickly in augmented reality, the information processing device 1 can display the virtual object with high image quality with a low load even when a fast movement of the line of sight cannot be followed.

In addition, the virtual object has visual attraction greater than or equal to a predetermined value. As a result, the information processing device 1 can suppress a decrease in visibility of the virtual object in a case where the user is attracted by the visual attraction and moves the line of sight toward the virtual object at a high speed.

In addition, the virtual object is a moving object that can move in the virtual space. Furthermore, in a case where the virtual object shifts from a stop state to a high-speed moving state, the information processing device 1 can suppress a decrease in the visibility of the virtual object.

In addition, the virtual object is an icon that functions as a graphical user interface that receives user's operation input. As a result, for example, in a case where a plurality of virtual objects having similar icons is arranged like in a menu screen, in cases where the order of viewing varies depending on a person such as from the left to the right or from the top to the bottom and the viewing is carried out quickly, even in a case where it is difficult to predict the movement of the line of sight and to set the icons to have high resolution, the information processing device 1 can display the icons with high image quality.

The graphical user interface also includes text information. As a result, the information processing device 1 can suppress a decrease in the visibility of the text information in a case where the user confirms the text information while moving the line of sight at a high speed.

Furthermore, the resolution control unit 14 expands the high-resolution region to a region including a plurality of virtual objects. As a result, in a case where the user confirms a plurality of virtual objects while moving the line of sight at a high speed, the information processing device 1 can suppress a decrease in the visibility of the virtual objects. Furthermore, for example, when attacking opponents or targets of a plurality of virtual objects in an augmented reality game, a virtual reality game, or the like, the information processing device 1 can display the virtual objects with a low load and high image quality even for a movement of quickly moving the line of sight one after another.

In addition, an attribute is associated with each of the plurality of virtual objects. The resolution control unit 14 expands the high-resolution region to a region including another virtual object associated with the same attribute as that of the virtual object that has entered the high-resolution region. As a result, the information processing device 1 can suppress a decrease in the visibility of the virtual object that the user is likely to direct the line of sight after the virtual object that has entered the high-resolution region.

Furthermore, the resolution control unit 14 expands the high-resolution region to a region including a virtual object displayed in a region whose distance from the gaze point is less than or equal to a threshold value among the plurality of virtual objects. As a result, the information processing device 1 can reduce the processing load by suppressing expansion of the high-resolution region more than necessary.

Furthermore, the resolution control unit 14 expands the high-resolution region in a non-circular shape. As a result, the information processing device 1 can expand the high-resolution region so as to have an appropriate shape depending on the situation.

Furthermore, the resolution control unit 14 expands the high-resolution region to a non-circular shape corresponding to the shape of the virtual object. As a result, the information processing device 1 can reduce the processing load by minimizing the expansion range of the high-resolution region to the necessary minimum that matches the shape of the virtual object.

Furthermore, in a case where the virtual object disappears from the display image, the resolution control unit 14 returns the size of the high-resolution region to the size before expansion. As a result, in a case where no virtual object is displayed, the information processing device 1 can reduce the processing load by minimizing the range of the high-resolution region to the necessary minimum.

The display device is a head-mounted display. As a result, the information processing device 1 can suppress a decrease in the visibility of the display image in a case where the user's line of sight moves at a high speed toward a virtual object superimposed on an image of virtual reality or augmented reality displayed by the head-mounted display.

Furthermore, the display device is a video see-through display that images and displays the real space in front of the eyes of the user. As a result, the information processing device 1 can suppress a decrease in the visibility of the display image in a case where the line of sight of the user moves at a high speed toward the virtual object superimposed on the image of the real space.

Meanwhile, the information processing device 1 includes the real space imaging unit 10, the real space recognition unit 11, the self-position estimation unit 12, and the image generation unit 13. The real space imaging unit 10 captures an image of the real space. The real space recognition unit 11 recognizes feature points of the real space from an image captured by the real space imaging unit 10. The self-position estimation unit 12 estimates the self-position of the user in the virtual space on the basis of the feature points of the real space. The image generation unit 13 generates a virtual object to be superimposed and displayed on the image in which the real space is captured. As a result, the information processing device 1 can generate the virtual object accurately aligned with the real space.

The information processing device 1 further includes the line-of-sight imaging unit 15, the line-of-sight recognition unit 16, and the line-of-sight position calculating unit 17. The line-of-sight imaging unit 15 captures an image of the eyes of the user. The line-of-sight recognition unit 16 recognizes the feature points of the eyes from the image captured by the line-of-sight imaging unit 15. The line-of-sight position calculating unit 17 calculates the gaze point of the user on the basis of the feature points of the eyes. As a result, the information processing device 1 can accurately calculate the gaze point of the user.

Alternatively, the display device may be a non-transmissive display that displays three-dimensional virtual reality. As a result, the information processing device 1 can suppress a decrease in the visibility of the display image in a case where the line of sight of the user moves at a high speed toward the virtual object superimposed on the image of the virtual reality.

Furthermore, the resolution control unit 14 sets the entire background image of the virtual reality as a low-resolution region. As a result, the information processing device 1 can reduce the drawing load by setting only a virtual object that is considered to be gazed at when the line of sight moves quickly to have high resolution and setting the background to have low resolution even in the gaze range.

Meanwhile, an information processing method includes setting, by a processor, a high-resolution region including a gaze point of the user and a low-resolution region not including the gaze point of the user with respect to the display image displayed by the display device and temporarily expanding the high-resolution region toward a virtual object in a case where the virtual object enters the high-resolution region. As a result, the processor can suppress a decrease in the visibility of the display image when the user's line of sight moves at a high speed toward the virtual object.

Furthermore, a recording medium records a program for causing a computer to function as a resolution control unit that sets a high-resolution region including a gaze point of a user and a low-resolution region not including the gaze point of the user to a display image displayed by a display device and temporarily expands the high-resolution region toward a virtual object in a case where the virtual object enters the high-resolution region. As a result, the computer can suppress a decrease in the visibility of the display image when the user's line of sight moves at a high speed toward the virtual object.

Note that the effects described herein are merely examples and are not limited, and other effects may also be achieved.

Note that the present technology can also have the following configurations.

(1)

An information processing device comprising:

a resolution control unit that sets a high-resolution region including a gaze point of a user and a low-resolution region not including the gaze point of the user to a display image displayed by a display device and temporarily expands the high-resolution region toward a virtual object in a case where the virtual object enters the high-resolution region.

(2)

The information processing device according to (1),

wherein the virtual object

is an object that moves in a three-dimensional virtual space.

(3)

The information processing device according to (1),

wherein the virtual object

has visual attraction greater than or equal to a predetermined value.

(4)

The information processing device according to (3),

wherein the virtual object

is a moving object capable of moving in a virtual space.

(5)

The information processing device according to (3),

wherein the virtual object

is an icon that functions as a graphical user interface that receives operation input of the user.

(6)

The information processing device according to (5),

wherein the graphical user interface

includes text information.

(7)

The information processing device according to (1),

wherein the resolution control unit

expands the high-resolution region to a region including a plurality of the virtual objects.

(8)

The information processing device according to (7),

wherein each of the plurality of the virtual objects is

associated with an attribute, and

the resolution control unit

expands the high-resolution region to a region including another virtual object associated with a same attribute as an attribute of the virtual object that has entered the high-resolution region.

(9)

The information processing device according to (8),

wherein the resolution control unit

expands the high-resolution region to a region including the virtual object displayed in a region whose distance from the gaze point is less than or equal to a threshold value among the plurality of the virtual objects.

(10)

The information processing device according to (1),

wherein the resolution control unit

expands the high-resolution region in a non-circular shape.

(11)

The information processing device according to (10),

wherein the resolution control unit

expands the high-resolution region in the non-circular shape corresponding to a shape of the virtual object.

(12)

The information processing device according to (1),

wherein the resolution control unit

returns a size of the high-resolution region to a size before expansion in a case where the virtual object disappears from the display image.

(13)

The information processing device according to (1),

wherein the display device

is a head-mounted display.

(14)

The information processing device according to (1),

wherein the display device

is a video see-through display that images and displays a real space in front of eyes of the user.

(15)

The information processing device according to (14), further comprising:

a real space imaging unit that captures an image of the real space;

a real space recognition unit that recognizes a feature point of the real space from the image captured by the real space imaging unit;

a self-position estimation unit that estimates a self-position of the user in a virtual space on the basis of the feature point of the real space; and

an image generation unit that generates the virtual object to be superimposed and displayed on the image in which the real space is captured.

(16)

The information processing device according to (15), further comprising:

a line-of-sight imaging unit that captures an image of eyes of the user;

a line-of-sight recognition unit that recognizes a feature point of the eyes from the image captured by the line-of-sight imaging unit; and

a line-of-sight position calculating unit that calculates a gaze point of the user on the basis of the feature point of the eyes.

(17)

The information processing device according to (1),

wherein the display device

is a non-transmissive display that displays three-dimensional virtual reality.

(18)

The information processing device according to (17),

wherein the resolution control unit

sets an entire background image of the virtual reality as the low-resolution region.

(19)

An information processing method comprising:

by a processor,

setting a high-resolution region including a gaze point of a user and a low-resolution region not including the gaze point of the user with respect to a display image displayed by a display device and temporarily expanding the high-resolution region toward a virtual object in a case where the virtual object enters the high-resolution region.

(20)
20. A recording medium recording a program for causing a computer to function as

a resolution control unit that sets a high-resolution region including a gaze point of a user and a low-resolution region not including the gaze point of the user to a display image displayed by a display device and temporarily expands the high-resolution region toward a virtual object in a case where the virtual object enters the high-resolution region.

### REFERENCE SIGNS LIST

1 INFORMATION PROCESSING DEVICE
10 REAL SPACE IMAGING UNIT
11 REAL SPACE RECOGNITION UNIT
12 SELF-POSITION ESTIMATION UNIT
13 IMAGE GENERATION UNIT
14 RESOLUTION CONTROL UNIT
15 LINE-OF-SIGHT IMAGING UNIT
16 LINE-OF-SIGHT RECOGNITION UNIT
17 LINE-OF-SIGHT POSITION CALCULATING UNIT
18 IMAGE PROCESSING UNIT
19 IMAGE DISPLAY UNIT
2 USER
3 OPPONENT PLAYER
4 GAZE POINT
5, 51 to 54, 81 to 87, 91, 92 HIGH-RESOLUTION REGION
61 to 64 TARGET
70 to 79 SETTING ITEM ICON

1. An information processing device comprising:
a resolution control unit that sets a high-resolution region including a gaze point of a user and a low-resolution region not including the gaze point of the user to a display image displayed by a display device and temporarily expands the high-resolution region toward a virtual object in a case where the virtual object enters the high-resolution region.

2. The information processing device according to claim 1,
wherein the virtual object
is an object that moves in a three-dimensional virtual space.

3. The information processing device according to claim 1,
wherein the virtual object
has visual attraction greater than or equal to a predetermined value.

4. The information processing device according to claim 3,
wherein the virtual object
is a moving object capable of moving in a virtual space.

5. The information processing device according to claim 3,
wherein the virtual object
is an icon that functions as a graphical user interface that receives operation input of the user.

6. The information processing device according to claim 5,
wherein the graphical user interface
includes text information.

7. The information processing device according to claim 1,
wherein the resolution control unit
expands the high-resolution region to a region including a plurality of the virtual objects.

8. The information processing device according to claim 7,
wherein each of the plurality of the virtual objects is associated with an attribute, and
the resolution control unit
expands the high-resolution region to a region including another virtual object associated with a same attribute as an attribute of the virtual object that has entered the high-resolution region.

9. The information processing device according to claim 8,
wherein the resolution control unit
expands the high-resolution region to a region including the virtual object displayed in a region whose distance from the gaze point is less than or equal to a threshold value among the plurality of the virtual objects.

10. The information processing device according to claim 1,
wherein the resolution control unit
expands the high-resolution region in a non-circular shape.

11. The information processing device according to claim 10,
wherein the resolution control unit
expands the high-resolution region in the non-circular shape corresponding to a shape of the virtual object.

12. The information processing device according to claim 1,
wherein the resolution control unit
returns a size of the high-resolution region to a size before expansion in a case where the virtual object disappears from the display image.

13. The information processing device according to claim 1,
wherein the display device
is a head-mounted display.

14. The information processing device according to claim 1,
wherein the display device
is a video see-through display that images and displays a real space in front of eyes of the user.

15. The information processing device according to claim 14, further comprising:
a real space imaging unit that captures an image of the real space;
a real space recognition unit that recognizes a feature point of the real space from the image captured by the real space imaging unit;
a self-position estimation unit that estimates a self-position of the user in a virtual space on the basis of the feature point of the real space; and
an image generation unit that generates the virtual object to be superimposed and displayed on the image in which the real space is captured.

16. The information processing device according to claim 15, further comprising:
a line-of-sight imaging unit that captures an image of eyes of the user;
a line-of-sight recognition unit that recognizes a feature point of the eyes from the image captured by the line-of-sight imaging unit; and
a line-of-sight position calculating unit that calculates a gaze point of the user on the basis of the feature point of the eyes.

17. The information processing device according to claim 1,
wherein the display device
is a non-transmissive display that displays three-dimensional virtual reality.

18. The information processing device according to claim 17,
wherein the resolution control unit
sets an entire background image of the virtual reality as the low-resolution region.

19. An information processing method comprising:
by a processor,
setting a high-resolution region including a gaze point of a user and a low-resolution region not including the gaze point of the user with respect to a display image displayed by a display device and temporarily expanding the high-resolution region toward a virtual object in a case where the virtual object enters the high-resolution region.

20. A recording medium recording a program for causing a computer to function as
a resolution control unit that sets a high-resolution region including a gaze point of a user and a low-resolution region not including the gaze point of the user to a display image displayed by a display device and temporarily expands the high-resolution region toward a virtual object in a case where the virtual object enters the high-resolution region.
